(19) United States
(12) Patent Application Publication
(10) Pub. No.: US 2019/0098731 A1
(43) Pub. Date: Mar. 28, 2019

(54) Programmable flashlight with automatic light intensity adjustment means

(71) Applicant: Shiu-Fai Stephen MAN, N.T. (HK)

(72) Inventor: Shiu-Fai Stephen MAN, N.T. (HK)

(21) Appl. No.: 16/202,096

(22) Filed: Nov. 28, 2018

Related U.S. Application Data
(63) Continuation-in-part of application No. 15/694,873, filed on Sep. 4, 2017, now abandoned.

(51) Int. Cl. H05B 37/02; F21L 4/00; F21V 23/04

(52) U.S. Cl. CPC H05B 37/0227; H05B 37/0281; F21V 23/0442; F21L 4/005

(57) ABSTRACT

A programmable flashlight with automatic light intensity adjustment means includes a flashlight casing, a light source, a programmable switch, a printed circuit board with a microprocessor coupled thereon, a power source and a sensor component. A light controlling program operable by the microprocessor is adapted to control electrical current passing through the light source according to intensity of incident light as detected by the sensor. A programming program operable by the microprocessor is adapted to control the programming of the functional sequence of the programmable switch and/or the parameters of each of the operation modes by sensing a sequence of ON and OFF light flashes as generated by an external device.

### BACKGROUND OF THE INVENTION

The present invention relates to a programmable flashlight with automatic light intensity adjustment means and more particularly pertains to a flashlight which is programmable using a sequence of light flashes and capable of automatically adjusting the light intensity according to the intensity of incident light reflected from the nearest object facing the light source of the flashlight.

Flashlights are indispensable for various outdoor activities such as camping and mountain climbing. Especially in countryside where public lighting facilities and installations are rare, it is essential for people to use their own flashlights for conducting various activities in the dark, such as reading the map, finding the way and so forth. If the light intensity of the flashlight is not high enough, only the area within a limited distance can be illuminated and so users are prone to get injured by running into obstacles in the dark. However, if the light intensity of the torch is too high, it is difficult for the human eyes to adapt to the strong light in the dark and so users cannot see things clearly in the adjacent area. This poses serious problems especially for map reading. To solve the aforementioned problem, some flashlights available in the marketplace are equipped with manual light intensity adjustment means. However, they are not user-friendly and user usually wastes much effort on switching to the suitable level of light intensity. Therefore, there is a need for flashlights with automatic light intensity means which can conveniently provide the appropriate level of light for users.

Currently, there are some flashlights with various operation modes, e.g. LOW (low light intensity), HIGH (high light intensity), STROBE (light flashes at a regular interval) and so forth. For some flashlights it is possible to program the operation modes by pressing specific function buttons on the flashlight. However, as the size of the flashlight is compact, there is not much room for setting such function buttons and the explanation on the operation thereof on the flashlight. The user needs to refer to the operation manual for the operation method. It is therefore very difficult for the user to program the flashlight using the function buttons on the flashlight, and only limited functions could be programmed in this way. Alternatively, there are flashlights which may be connected to smart phones via Bluetooth and users may program the flashlights by apps installed in the smart phones. However, as it is necessary to install wireless communication components in the flashlights, the costs of the flashlights are higher. As the apps are usually provided on different platforms, it is necessary to develop different versions of the apps for different platforms, thus the development costs are high.

### BRIEF SUMMARY OF THE INVENTION

In view of the aforesaid disadvantages now present in the prior art, an object of the present invention is to provide a flashlight capable of detecting the intensity of light as reflected by the nearest object facing the light source of the flashlight and automatically adjusting the light intensity according to the light intensity of light as detected by the flashlight. In principle, the farther away an object is located from the light source of the flashlight, the less intense is the light reflected by the object, and the flashlight is automatically adjusted to provide stronger light. Furthermore, the lower the reflectivity of the surface of the object, the less intense is the light reflected by the object and the flashlight is automatically adjusted to provide stronger light. The present invention therefore provides users with optimal level of lighting in the dark without blinding users with bright light. The automatic adjustment means also saves users the trouble of manually adjusting the light intensity.

It is another object of the present invention to provide a sensor component which is prevented from being affected by ambient light which are not reflected by the nearest object facing the light source of the flashlight.

A further object of the present invention is to provide a programmable flashlight with an easy, convenient and highly flexible means for programming the functional sequence of the programmable switch of the flashlight as well as programming various parameters such as the brightness, strobing frequency and so forth of each of the operation modes of the flashlight.

To attain this, the present invention comprises a flashlight casing, a light source operable among a plurality of operation modes with each of the operation modes having a plurality of programmable parameters, a programmable switch for controlling the light source to switch among the plurality of operation modes according to a functional sequence, a printed circuit board with a microprocessor coupled thereon, and a power source. A sensor component is attached to the flashlight casing, and the sensor component comprises a sensor casing and a sensor disposed therein, and the sensor is electronically connected to the light source, the switch, the printed circuit board and the power source. A light controlling program operable by the microprocessor is adapted to control electrical current passing through the light source according to intensity of incident light as detected by the sensor so that more current is passed through the light source when a lower intensity of incident light is detected, and less current is passed through the light source when a higher intensity of incident light is detected. A programming program operable by the microprocessor is adapted to control the sensor to sense a sequence of ON and OFF light flashes as generated by an external device with the sequence of ON and OFF light flashes being a representation of a binary code signal for programming the functional sequence of the programmable switch and/or the parameters of each of the operation modes, decode the sequence of ON and OFF light flashes sensed by the sensor to the corresponding binary code signal, and program the functional sequence of the programmable switch and/or the parameters of each of the operation modes with the decoded binary code signal.

In some embodiments, binary ONE of the binary code signal is represented by an OFF light flash for a first time period followed by an ON light flash for a second time period, while binary ZERO of the binary code signal is represented by an OFF light flash for a third time period followed by an ON light flash for a fourth time period; the first time period, the second time period, the third time period and the fourth time period are chosen so that binary ONE and binary ZERO are uniquely and unambiguously represented. For example, the first time period is the same as the second time period; the third time period is the same as the fourth time period but different from the first time period and the second time period.

The sequence of ON and OFF light flashes may further comprise a control signal which indicates beginning and/or end of the sequence of ON and OFF light flashes; the control signal is represented by an OFF light flash for a fifth time period and an ON light flash for a sixth time period at beginning and/or end of the sequence of ON and OFF light flashes; the fifth time period and the sixth time period are chosen so that the control signal is uniquely and unambiguously represented. For example, the fifth time period is the same as the sixth time period but different from the first, second, third and fourth time period.

Alternatively, in some embodiments, binary ONE of the binary code signal is represented by an ON light flash for a first time period followed by an OFF light flash for a second time period, while binary ZERO of the binary code signal is represented by an ON light flash for a third time period followed by an OFF light flash for a fourth time period; the first time period, the second time period, the third time period and the fourth time period are chosen so that binary ONE and binary ZERO are uniquely and unambiguously represented. For example, the first time period is the same as the second time period; the third time period is the same as the fourth time period but different from the first time period and the second time period. The sequence of ON and OFF light flashes may further comprise a control signal which indicates beginning and/or end of the sequence of ON and OFF light flashes; the control signal is represented by an ON light flash for a fifth time period and an OFF light flash for a sixth time period at beginning and/or end of the sequence of ON and OFF light flashes; the fifth time period and the sixth time period are chosen so that the control signal is uniquely and unambiguously represented. For example, the fifth time period is the same as the sixth time period but different from the first, second, third and fourth time period.

In some embodiments, the external device is configured to generate the sequence of ON and OFF light flashes in a number of recurring cycles.

In some embodiments, the sequence of ON and OFF light flashes is in form of an animated graphic image displayed on a display means of the external device.

In some embodiments, the external device is in form of a computer or a mobile phone.

In some embodiments, the sequence of ON and OFF light flashes is in form of another sequence of ON and OFF light flashes generated by another flashlight.

In some embodiments, the sensor casing is elongated in shape, and the sensor casing has an interior surface which is dark in color.

In some embodiments, a plurality of discs are disposed inside the sensor casing, and each of the discs is disposed with a center through hole so that light passes through the through holes before reaching the sensor.

In some embodiments, the printed circuit board is disposed inside the flashlight casing, and the sensor is connected to the printed circuit board by means of wires passing through an opening in the flashlight casing.

In some embodiments, the printed circuit board is disposed inside the sensor casing, and the sensor is connected to the printed circuit board by means of wires.

In some embodiments, the light controlling program is configured to provide a current stabilizing function which stabilizes the electrical current passing through the light source when the intensity of incident light as detected by the sensor fluctuates.

In some embodiments, the sensor takes the form of a photoresistor.

In some embodiments, the light controlling program is preset with one or more incident light intensity threshold levels, each of which corresponds to a preset level of electrical current to be controlled by the light controlling program to pass through the light source.

By the provision of the sensor casing, the sensor is prevented from receiving light which is not reflected by the nearest object facing the light source of the flashlight. The present invention can therefore determine the intensity of incident light reflected from the nearest object facing the flashlight more accurately, thereby providing a more appropriate light level accordingly.

Furthermore, since the flashlight of the present invention is capable of automatically adjusting the light intensity according to the lighting needs of the users, the present invention can reduce wastage of energy to provide excessive light. The battery life of the present invention can therefore be maximized.

### BRIEF DESCRIPTION OF THE DRAWINGS

FIG. 1 is an exploded view of an embodiment of the present invention.

FIG. 2 is a cross-sectional view of the embodiment of the present invention as shown in FIG. 1.

FIG. 3 is a block diagram of the embodiment of the present invention as shown in FIG. 1.

### DETAILED DESCRIPTION OF THE INVENTION

The present invention is further described in detail with the following embodiments.

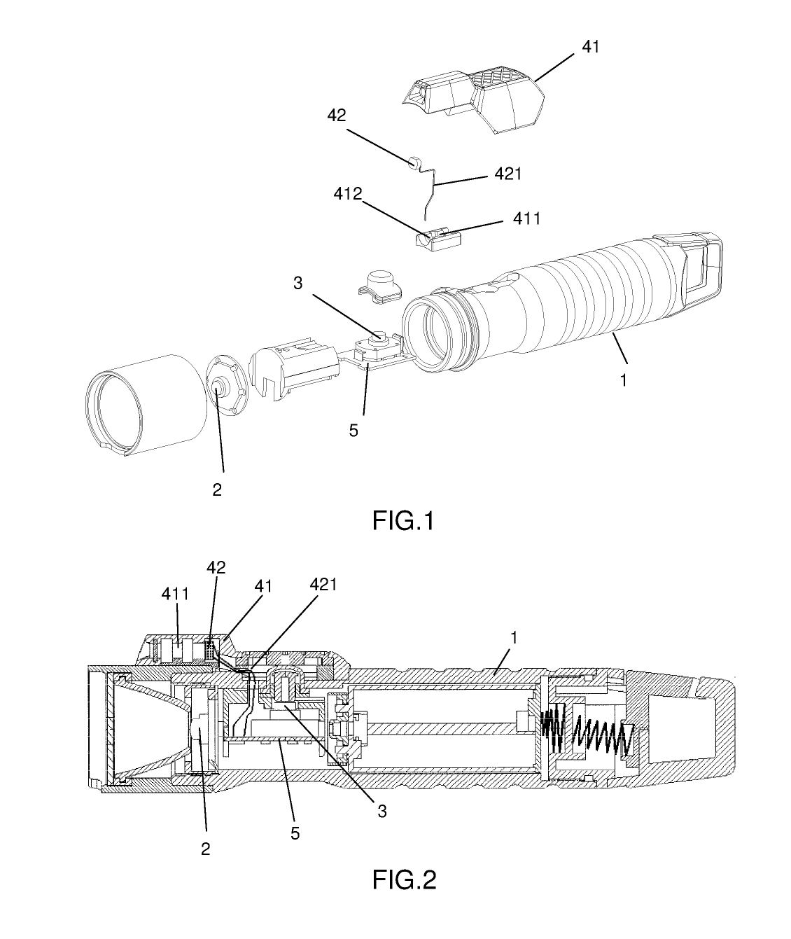

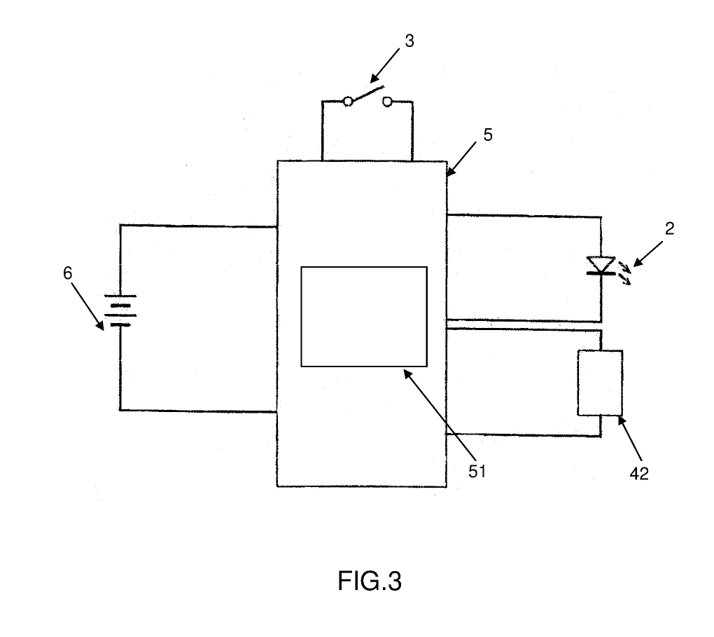

As illustrated in FIGS. 1 to 3, the present invention comprises a flashlight casing 1, a light source 2, a programmable switch 3, a printed circuit board 5 with a microprocessor 51 provided thereon, and a power source 6. In the present embodiment, the power source 6 takes the form of three 1.5V batteries, providing a voltage of 4.5V. A sensor component is attached to the flashlight casing 1, and the sensor component comprises a sensor casing 41 and a sensor 42 disposed therein. In this embodiment, the sensor 42 is a photoresistor. The sensor 42 is electronically connected to the light source 2, the switch 3, the printed circuit board 5 and the power source 6. The sensor casing 41 is elongated in shape, and the interior surface of the sensor casing 41 is dark in color. A plurality of discs 411 are disposed inside the sensor casing 41, and each of the discs 411 is disposed with a center through hole 412 so that light passes through the through holes 412 before reaching the sensor 42. In this embodiment, the printed circuit board 5 is disposed inside the flashlight casing 1. The sensor 42 is connected to the printed circuit board 5 by means of wires 421 passing through an opening in the flashlight casing 1. In other embodiments, the printed circuit board 5 may also be disposed inside the sensor casing 41, and the sensor 42 may be connected to the printed circuit board 5 by other conventional means.

In this embodiment, the light source 2 is operable among five operation modes, namely HIGH, LOW, STROBE, AUTO and OFF. Each of the operation modes has a plurality of programmable parameters, such as brightness, strobing frequency and so forth. The programmable switch 3 is capable of controlling the light source 2 to switch among the plurality of operation modes according to a functional sequence. An exemplary functional sequence is “LOW; HIGH; STROBE; AUTO; OFF”, meaning upon pushing the programmable switch 3 of the flashlight for the first time, the flashlight enters LOW mode in which the light intensity is low; upon pushing the programmable switch 3 for the second time, the flashlight enters HIGH mode in which the light intensity is high; upon pushing the programmable switch 3 for the third time, the flashlight enters STROBE mode in which the flashlight flashes at a regular interval; upon pushing the programmable switch 3 for the fourth time, the flashlight enters AUTO mode in which the light intensity is automatically adjusted according to the intensity of incident light as detected by the sensor 42; upon pushing the programmable switch 3 for the fifth time, the flashlight is switched off; upon pushing the programmable switch 3 for the sixth time, the flashlight enters LOW mode again.

It is possible to program the functional sequence of the programmable switch 3 and/or the parameters of each of the operation modes. A programming program operable by the microprocessor 51 is adapted to control the sensor 42 to sense a sequence of ON and OFF light flashes as generated by an external device with the sequence of ON and OFF light flashes being a representation of a binary code signal for programming the functional sequence of the programmable switch 3 and/or the parameters of each of the operation modes, decode the sequence of ON and OFF light flashes sensed by the sensor 42 to the corresponding binary code signal, and program the functional sequence of the programmable switch 3 and/or the parameters of each of the operation modes with the decoded binary code signal.

In this embodiment, binary ONE of the binary code signal is represented by an OFF light flash for a first time period followed by an ON light flash for a second time period, while binary ZERO of the binary code signal is represented by an OFF light flash for a third time period followed by an ON light flash for a fourth time period; the first time period, the second time period, the third time period and the fourth time period are chosen so that binary ONE and binary ZERO are uniquely and unambiguously represented. In this embodiment, the first time period and the second time period are both 200 ms, the third time period and the fourth time period are both 100 ms. The sequence of ON and OFF light flashes further comprises a control signal which indicates beginning of the sequence of ON and OFF light flashes; the control signal is represented by an OFF light flash for a fifth time period and an ON light flash for a sixth time period at beginning of the sequence of ON and OFF light flashes; the fifth time period and the sixth time period are chosen so that the control signal is uniquely and unambiguously represented. In this embodiment, the fifth time period and the sixth time period are both 500 ms.

To program the functional sequence of the programmable switch 3, the user first downloads an app and installs the app to his mobile phone (which constitutes the external device). The user then activates the app in his mobile phone. One aspect of the app is designed to direct the user to select one of a number of functional sequences of the programmable switch 3 of the flashlight. In this embodiment, two functional sequences of the programmable switch 3 are provided. The first functional sequences of the programmable switch 3 is “LOW; HIGH; STROBE; AUTO; OFF”. The second functional sequence of the programmable switch 3 is “HIGH; LOW; AUTO; STROBE; OFF”. When the user selects the first functional sequence of the programmable switch 3 in the app, the app is configured to display a sequence of ON and OFF light flashes in form of an animated graphic image on a display screen of the mobile phone. The sequence of ON and OFF light flashes is a representation of a control signal which indicates beginning of the sequence of ON and OFF light flashes and a binary code signal for programming the programmable switch 3 of the flashlight according to the first functional sequence. More particularly, the sequence of ON and OFF light flashes for programming the programmable switch 3 of the flashlight according to the first functional sequence is as follows: OFF 500 ms-ON 500 ms-OFF 200 ms-ON 200 ms-OFF 100 ms-ON 100 ms-OFF 100 ms-ON 100 ms-OFF 100 ms-ON 100 ms-OFF 100 ms-ON 100 ms-OFF 200 ms-ON 200 ms-OFF 100 ms-ON 100 ms-OFF 100 ms-ON 100 ms-OFF 100 ms-ON 100 ms-OFF 100 ms-ON 100 ms-OFF 200 ms-ON 200 ms-OFF 100 ms-ON 100 ms-OFF 100 ms-ON 100 ms-OFF 100 ms-ON 100 ms-OFF 100 ms-ON 100 ms-OFF 200 ms-ON 200 ms. The aforementioned sequence of ON and OFF light flashes corresponds to a control signal indicating the beginning of the sequence, followed by the binary codes 1000010000100001. The sequence of ON and OFF light flashes for programming the programmable switch 3 of the flashlight according to the second functional sequence is as follows: OFF 500 ms-ON 500 ms-OFF 100 ms-ON 100 ms-OFF 200 ms-ON 200 ms-OFF 100 ms-ON 100 ms-OFF 100 ms-ON 100 ms-OFF 100 ms-ON 100 ms-OFF 100 ms-ON 100 ms-OFF 200 ms-ON 200 ms-OFF 100 ms-ON 100 ms-OFF 100 ms-ON 100 ms-OFF 100 ms-ON 100 ms-OFF 100 ms-ON 100 ms-OFF 200 ms-ON 200 ms-OFF 200 ms-ON 200 ms-OFF 100 ms-ON 100 ms-OFF 100 ms-ON 100 ms-OFF 100 ms-ON 100 ms. The aforementioned sequence of ON and OFF light flashes corresponds to a control signal indicating the beginning of the sequence, followed by the binary codes 0100001000011000. Another aspect of the app is designed to direct the user to program various parameters such as the brightness, strobing frequency and so forth of each of the operation modes. For example, a sequence of ON and OFF light flashes may be preset to program the brightness of the HIGH mode to level 1, while another sequence of ON and OFF light flashes may be preset to program the brightness of the HIGH mode to level 2. The display screen of the mobile phone is configured to display the sequence of ON and OFF light flashes in a number of recurring cycles.

As the app begins to display the sequence of ON and OFF light flashes, the user positions the sensor component of the flashlight close to the display screen of the mobile phone and presses a predetermined switch on the flashlight (or by other conventional means) so that the flashlight enters a “programming mode”, and the programming program operable by the microprocessor 51 then controls the sensor 42 to sense the sequence of ON and OFF light flashes displayed by the display screen of the mobile phone, decodes the sequence of ON and OFF light flashes sensed by the sensor 42 to the corresponding binary code signal, and programs the functional sequence of the programmable switch 3 and/or the parameters of each of the operation modes with the decoded binary code signal. As the sequence of ON and OFF light flashes is displayed in recurring cycles, after the presence of the control signal is detected for the first time, the programming program proceeds to decode the sequence of ON and OFF light flashes to the binary code signal, and after detection of the presence of the control signal for the second time, the programming program then programs the functional sequence of the programmable switch 3 of the flashlight and/or the parameters of each of the operation modes with the decoded binary code signal.

As such, the system of the present invention offers an easy, convenient and highly flexible way for programming the functional sequence of the programmable switch 3 of the flashlight as well as programming various parameters such as the brightness, strobing frequency and so forth of each of the operation modes. As binary codes are very common in the prior art, there is a possibility for the end user to create customized sequence of ON and OFF light flashes according to a set of rules provided by the flashlight manufacturer to program the flashlight in a specific way.

It is obvious that apart from flashlights, it is also possible for the present invention to be applied to other electrical devices such as headlights and so forth. In another embodiment, the external device may be in form of a display screen of a computer, and the user may access a webpage which contains a number of hyperlinks where users may click and display preset sequences of ON and OFF light flashes.

When the flashlight enters AUTO mode, a light controlling program operable by the microprocessor 51 is adapted to control electrical current passing through the light source 2 according to the intensity of incident light as detected by the sensor 42. When the flashlight enters AUTO mode, light is emitted from the light source 2. When the emitted light hits the nearest object facing the light source 2, the light will be reflected by the object towards the flashlight. The light reflected by the object constitutes the incident light which passes through the through holes 412 in the sensor casing 41 before reaching the sensor 42. The elongated sensor casing 41 effectively blocks the light not reflected by the object and therefore eliminates the influence of ambient light. The farther away an object is located from the light source 2, the less intense is the light reflected by the object, and so the intensity of incident light as detected by the sensor 42 is lower. Moreover, the lower the reflectivity of the surface of an object, the less intense is the light reflected by the object, and so the intensity of the incident light as detected by the sensor 42 is lower. A lower incident light intensity detected by the sensor 42 implies that more light is required to light the object, and so the light controlling program controls more electrical current to pass through the light source 2 to provide stronger light. On the contrary, the nearer an object is located from the light source 2, and the higher the reflectivity of the surface of an object, the intensity of incident light as detected by the sensor 42 is higher, and so less electrical current is passed through the light source 2 to provide weaker light. The light controlling program is also configured to provide a current stabilizing function which stabilizes the electrical current passing through the light source 2 when the intensity of incident light as detected by the sensor 42 fluctuates.

In this embodiment, the light controlling program is preset with one or more incident light intensity threshold levels, each of which corresponds to a preset level of electrical current to be controlled by the light controlling program to pass through the light source 2. In this embodiment, two incident light intensity threshold levels are preset in the light controlling program. When the incident light intensity detected is below the lower threshold level, the light controlling program controls the electrical current passing through the light source 2 to be at the highest level. When the incident light intensity level detected is between the lower threshold level and the higher threshold level, the light controlling program controls the electrical current passing through the light source 2 to be at the middle level. When the incident light intensity level detected exceeds the higher threshold level, the light controlling program controls the electrical current passing through the light source 2 to be at the lowest level. In other words, in this embodiment, the light source 2 is controlled by the light controlling program to emit three levels of light. Depending on the number of preset incident light intensity threshold levels in the light controlling program, it should be conceivable that the light source can be controlled to emit light of a wide range of intensity according to the incident light intensity as detected.

The above embodiment is one of the embodiments of the present invention. The present invention is capable of other embodiments and is not limited by the above embodiment. Any other variation, decoration, substitution, combination or simplification, whether in substance or in principle, not deviated from the spirit of the present invention, is replacement or substitution of equivalent effect and falls within the scope of protection of the present invention.

What is claimed is:

1. A programmable flashlight with automatic light intensity adjustment means which comprises
a flashlight casing,
a light source operable among a plurality of operation modes with each of the operation modes having a plurality of programmable parameters,
a programmable switch for controlling the light source to switch among the plurality of operation modes according to a functional sequence,
a printed circuit board with a microprocessor coupled thereon, and
a power source,
wherein a sensor component is attached to the flashlight casing, and the sensor component comprises a sensor casing and a sensor disposed therein, and the sensor is electronically connected to the light source, the switch, the printed circuit board and the power source;
a light controlling program operable by the microprocessor is adapted to control electrical current passing through the light source according to intensity of incident light as detected by the sensor so that more current is passed through the light source when a lower intensity of incident light is detected, and less current is passed through the light source when a higher intensity of incident light is detected;
a programming program operable by the microprocessor is adapted to
control the sensor to sense a sequence of ON and OFF light flashes as generated by an external device with the sequence of ON and OFF light flashes being a representation of a binary code signal for programming the functional sequence of the programmable switch and/or the parameters of each of the operation modes,
decode the sequence of ON and OFF light flashes sensed by the sensor to the corresponding binary code signal, and
program the functional sequence of the programmable switch and/or the parameters of each of the operation modes with the decoded binary code signal.

2. The programmable flashlight with automatic light intensity adjustment means as in claim 1, wherein binary ONE of the binary code signal is represented by an OFF light flash for a first time period followed by an ON light flash for a second time period, while binary ZERO of the binary code signal is represented by an OFF light flash for a third time period followed by an ON light flash for a fourth time period; the first time period, the second time period, the third time period and the fourth time period are chosen so that binary ONE and binary ZERO are uniquely and unambiguously represented.

3. The programmable flashlight with automatic light intensity adjustment means as in claim 1, wherein binary ONE of the binary code signal is represented by an ON light flash for a first time period followed by an OFF light flash for a second time period, while binary ZERO of the binary code signal is represented by an ON light flash for a third time period followed by an OFF light flash for a fourth time period; the first time period, the second time period, the third time period and the fourth time period are chosen so that binary ONE and binary ZERO are uniquely and unambiguously represented.

4. The programmable flashlight with automatic light intensity adjustment means as in claim 2, wherein the sequence of ON and OFF light flashes further comprises a control signal which indicates beginning and/or end of the sequence of ON and OFF light flashes.

5. The programmable flashlight with automatic light intensity adjustment means as in claim 4, wherein the control signal is represented by an OFF light flash for a fifth time period and an ON light flash for a sixth time period at beginning and/or end of the sequence of ON and OFF light flashes; the fifth time period and the sixth time period are chosen so that the control signal is uniquely and unambiguously represented.

6. The programmable flashlight with automatic light intensity adjustment means as in claim 3, wherein the sequence of ON and OFF light flashes further comprises a control signal which indicates beginning and/or end of the sequence of ON and OFF light flashes.

7. The programmable flashlight with automatic light intensity adjustment means as in claim 6, wherein the control signal is represented by an ON light flash for a fifth time period and an OFF light flash for a sixth time period at beginning and/or end of the sequence of ON and OFF light flashes; the fifth time period and the sixth time period are chosen so that the control signal is uniquely and unambiguously represented.

8. The programmable flashlight with automatic light intensity adjustment means as in claim 1, wherein the external device is configured to generate the sequence of ON and OFF light flashes in a number of recurring cycles.

9. The programmable flashlight with automatic light intensity adjustment means as in claim 1, wherein the sequence of ON and OFF light flashes is in form of an animated graphic image displayed on a display screen of the external device.

10. The programmable flashlight with automatic light intensity adjustment means as in claim 9, wherein the external device is in form of a computer or a mobile phone.

11. The programmable flashlight with automatic light intensity adjustment means as in claim 1, wherein the sequence of ON and OFF light flashes is in form of another sequence of ON and OFF light flashes generated by another flashlight.

12. The programmable flashlight with automatic light intensity adjustment means as in claim 1, wherein the sensor casing is elongated in shape, and the sensor casing has an interior surface which is dark in color.

13. The programmable flashlight with automatic light intensity adjustment means as in claim 1, wherein a plurality of discs are disposed inside the sensor casing, and each of the discs is disposed with a center through hole so that light passes through the through holes before reaching the sensor.

14. The programmable flashlight with automatic light intensity adjustment means as in claim 1, wherein the printed circuit board is disposed inside the flashlight casing, and the sensor is connected to the printed circuit board by means of wires passing through an opening in the flashlight casing.

15. The programmable flashlight with automatic light intensity adjustment means as in claim 1, wherein the printed circuit board is disposed inside the sensor casing, and the sensor is connected to the printed circuit board by means of wires.

16. The programmable flashlight with automatic light intensity adjustment means as in claim 1, wherein the light controlling program is configured to provide a current stabilizing function which stabilizes the electrical current passing through the light source when the intensity of incident light as detected by the sensor fluctuates.

17. The programmable flashlight with automatic light intensity adjustment means as in claim 1, wherein the sensor takes the form of a photoresistor.

18. The programmable flashlight with automatic light intensity adjustment means as in claim 1, wherein the light controlling program is preset with one or more incident light intensity threshold levels, each of which corresponds to a preset level of electrical current to be controlled by the light controlling program to pass through the light source.
